(19) United States
(12) Patent Application Publication
(10) Pub. No.: US 2026/0220936 A1
(43) Pub. Date: Jul. 30, 2026

(54) SYSTEM AND METHOD FOR PERFORMING A FOREST INVENTORY

(71) Applicant: THE UNITED STATES OF AMERICA AS REPRESENTED BY THE SECRETARY OF AGRICULTURE, WASHINGTON, DC (US)

(72) Inventors: Lucas Aaron Wells, Huson, MT (US); Anthony Marcozzi, Missoula, MT (US); Jenny Perth, Missoula, MT (US)

(73) Assignee: THE UNITED STATES OF AMERICA AS REPRESENTED BY THE SECRETARY OF AGRICULTURE, WASHINGTON, DC (US)

(21) Appl. No.: 19/036,115

(22) Filed: Jan. 24, 2025

(51) Int. Cl. G06V 20/20; G06T 7/13; G06T 7/62; G06T 7/73; G06T 11/00; G06V 10/44; G06V 20/10

(52) U.S. Cl. CPC G06V 20/20; G06T 7/13; G06T 7/62; G06T 7/74; G06T 11/00; G06V 10/457; G06V 20/188; G06T 2207/30188; G06T 2207/30204

(57) ABSTRACT

The system for performing a forest inventory is an augmented reality tool for producing augmented reality images of trees within a pre-established plot of land in which the augmented reality images of the trees are each virtually tagged with inventory-related data. A digital image of a tree and a surrounding region is recorded with a camera and displayed to a user. The digital image is overlayed with augmented reality tools which allow for determination of the diameter and height of the tree, and the digital image of the tree may be virtually tagged with a virtual tag including data representative of the diameter of the tree, the height of the tree and the location of the tree. The user may also append the virtual tag with data representative of the species of the tree.

### STATEMENT OF GOVERNMENT INTEREST

This invention was made with government support under contract no. 12443921C0018 awarded by the United States Department of Agriculture Forest Service. The government has certain rights in the invention.

### BACKGROUND

### Field

The disclosure of the present patent application relates to the measurement and recordation of forest inventory data, and particularly to an augmented reality-based system and method for performing forest inventories.

### Description of Related Art

Forest inventories are used for a number of different purposes where tree-related parameters, such as tree height, tree diameter, etc., within a particular plot of land will be useful. Traditional forest inventory methods rely on multiple specialized measurement tools, such as diameter tape, clinometers, angle gauges, and differing types of measuring tape. Although these manual tools are effective, their use is time consuming, requiring foresters to carry numerous pieces of equipment, take individual measurements, and record each measurement manually. Although laser scanning technology has recently been used to create three-dimensional models of forest plots, such systems are costly and still require manual tagging of certain tree characteristics that cannot be automatically detected, such as species, defect, and other contextual information. Thus, a system and method for performing a forest inventory to solve the aforementioned problems are desired.

### SUMMARY

The system for performing a forest inventory is an augmented reality tool for producing augmented reality images of trees within a pre-established plot of land in which the augmented reality images of the trees are each virtually tagged with inventory-related data. A geographic center of the pre-established plot of land is determined and a digital image of at least a portion of the pre-established plot of land is recorded. A reference marker image is overlayed on the digital image of the at least a portion of the pre-established plot of land at the geographic center thereof to provide a reference location and an augmented reality image of the reference location. A boundary of the pre-established plot of land may also be determined, and a boundary image may also be overlayed on the digital image of the at least a portion of the pre-established plot of land. The boundary image is representative of the boundary of the pre-established plot of land.

A digital image of a tree within the pre-established plot of land, and the surrounding region, is then recorded with a camera. The surrounding region includes at least a ground surface. A digital image of the tree and the surrounding region is displayed to a user and a vertical line is overlayed on the digital image of the tree and the surrounding region. The user positions the camera such that the vertical line is overlayed on the tree between edges thereof and such that a lower end of the vertical line overlays an intersection between a bottom of the tree and the ground surface. The edges of the tree in the digital image are identified and localized within the digital image.

A distance between the camera and the tree is measured and a virtual distance between the edges of the tree is automatically determined by the system and displayed in the digital image. The virtual distance is used to convert the width of the tree stem in the image to an actual caliper diameter (i.e., the “real world” diameter of the tree at the selected height from the ground). The location of the tree is determined, and the tree is virtually tagged in the digital image with a virtual tag including data representative of the diameter of the tree and the location of the tree. The boundary image of the boundary of the pre-established plot of land may also be overlayed on the digital image of the tree and the surrounding region.

Additionally, a height marker may be overlayed on the digital image of the tree and the surrounding region, such that the user can position the height marker such that the height marker is overlayed on the tree at a desired height. An angle of inclination of the camera is determined when the height marker is overlayed on the tree at the desired height, and the height of the tree at a point indicated by the height marker can then be determined based on the angle of inclination of the camera and the distance between the camera and the tree. The virtual tag associated with the tree may also include data representative of the height of the tree. The user may also append the virtual tag with data representative of the species of the tree. The above process can be performed for any desired number of trees within the pre-established plot of land.

These and other features of the present subject matter will become readily apparent upon further review of the following specification.

### BRIEF DESCRIPTION OF DRAWINGS

FIG. 1 is a screenshot illustrating the location and display of a center of a plot of land implemented by the system for performing a forest inventory.

FIG. 2A is a screenshot illustrating augmented reality tools used by a user for determining a diameter of a tree within the plot of land.

FIG. 2B is a simplified top view of the system for performing a forest inventory being used for determining the diameter of the tree.

FIG. 3 is a block diagram showing system components of the system for performing a forest inventory.

FIG. 4A and FIG. 4B illustrate the system for performing a forest inventory being used for measuring the height of a tree.

FIG. 5 is a screenshot illustrating an augmented reality tool used by the user to measure the height of the tree.

FIG. 6 is a screenshot illustrating trees within the plot of land virtually tagged with virtual tags including data associated with each tree.

Similar reference characters denote corresponding features consistently throughout the attached drawings.

### DETAILED DESCRIPTION

The system for performing a forest inventory 10 is an augmented reality tool for producing augmented reality images of trees within a pre-established plot of land in which the augmented reality images of the trees are each virtually tagged with inventory-related data. As is well-known in the art, forest inventories are typically conducted to assess and monitor forest conditions, including timber volume, forest health, biodiversity, and other management objectives, before implementing management actions or plans. Since performing a complete census of every tree is unfeasible, population samples within pre-defined plots of land are used. Such plots of land are typically either within a certain fixed area, such as circular plots with a fixed radius, or plots generated via point sampling, where the radius of the plot is variable based on the size of the tree. Such plots are typically laid out during a sampling design phase on a computer. As a non-limiting example, for a 100 acre stand of trees, a map may be generated of the 100-acre area and this map may be divided up into ten plots, each defined with stored coordinates (e.g., the latitude and longitude).

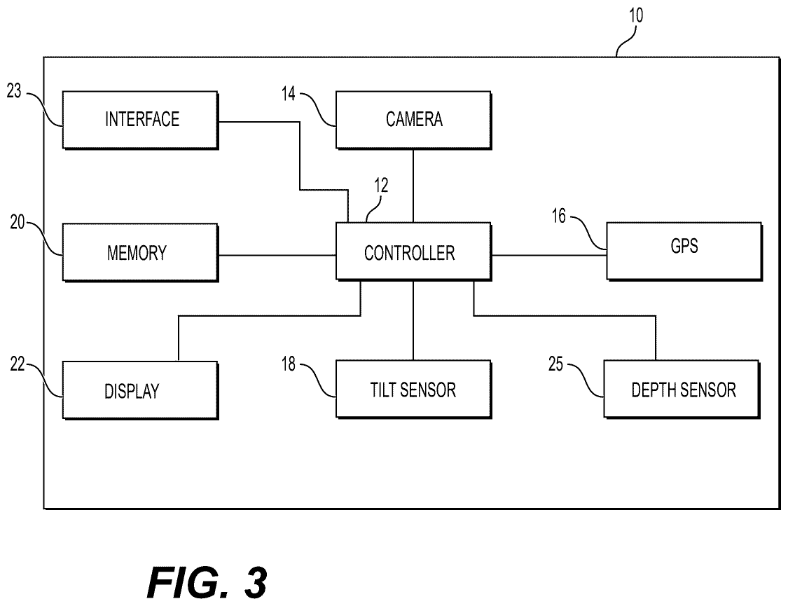

In use, for a particular pre-established plot of land, such as those described above, the user travels to the pre-established plot of land with system 10. As shown in FIG. 3, system 10 includes a location determining sub-system 16, such as a global positioning system (GPS) receiver, and non-transitory computer readable memory 20. It should be understood that any suitable type of location determining system or sub-system may be used. Cached maps of the region may be stored in the non-transitory computer readable memory 20 and the user may use the GPS receiver 16, as a non-limiting example, to help the user navigate to the pre-established plot of land. As will be discussed in greater detail below, the system 10 may be implemented using a conventional smartphone or the like. When the determined location of the user is near the center of the pre-established plot, the system 10 can notify the user using, for example, a visual indication to the user on display 22.

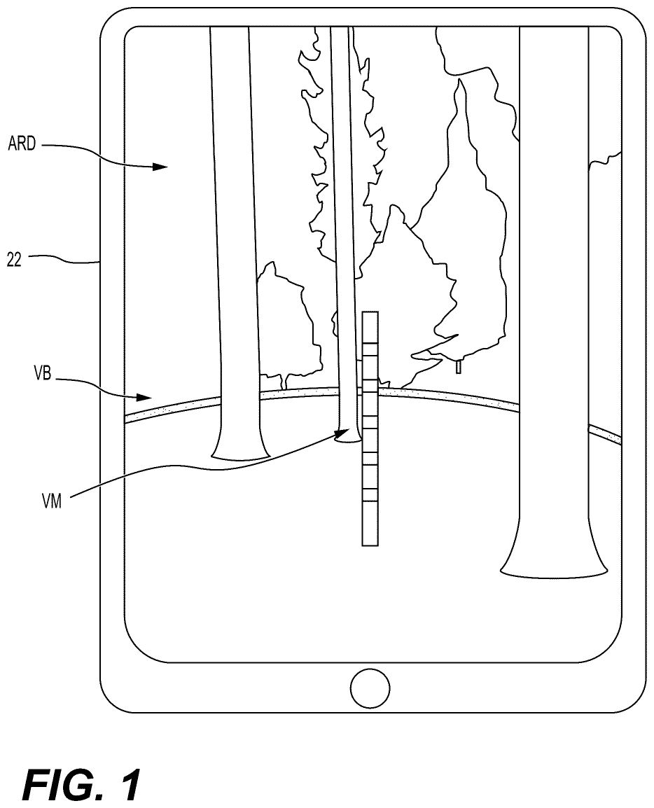

The geographic center of the pre-established plot of land may be pre-determined and, as shown in FIG. 1, a digital image of at least a portion of the pre-established plot of land is recorded. In FIG. 1, the digital image is represented as an augmented reality display (ARD) displayed to the user on the display 22. As noted above, system 10 may be implemented using, or may include, a mobile device, such as a smartphone, a tablet computer or the like, and display 22 may be, as a non-limiting example, a conventional smartphone display. It should be understood that system 10 may be implemented using, or may be used in combination with, any suitable type of mobile device and is not limited to smartphones, tablet computers, etc.

A reference marker image is overlayed on the augmented reality display (ARD) as a virtual marker (VM) at the geographic center of the plot of land to provide a reference location and an augmented reality image of the reference location. It should be understood that the style of the virtual marker (VM) shown in FIG. 1 is shown for exemplary purposes only. The boundary of the pre-established plot of land is also determined, and a boundary image in the form of a virtual boundary (VB) line may also be overlayed on the augmented reality display (ARD). The boundary image is representative of the physical boundary of the pre-established plot of land. The physical coordinates of the boundary and center of the plot may be stored in memory 20.

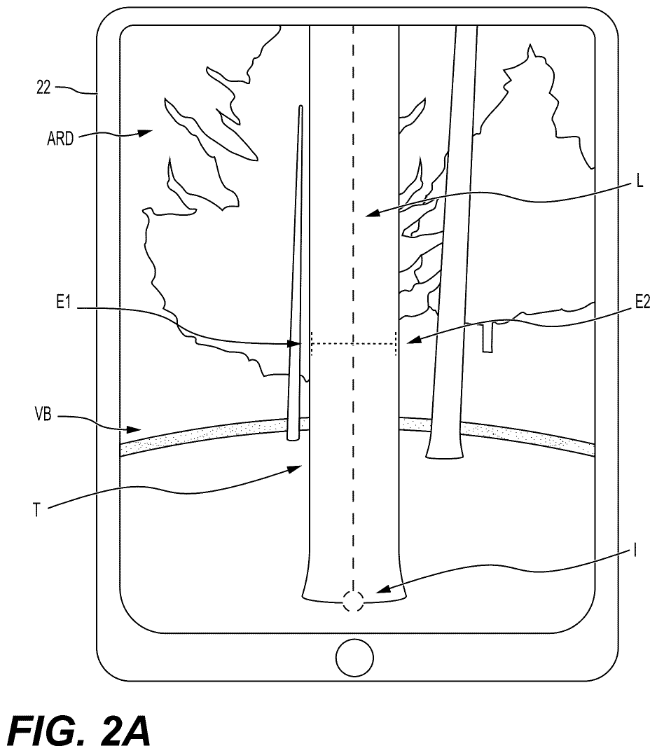

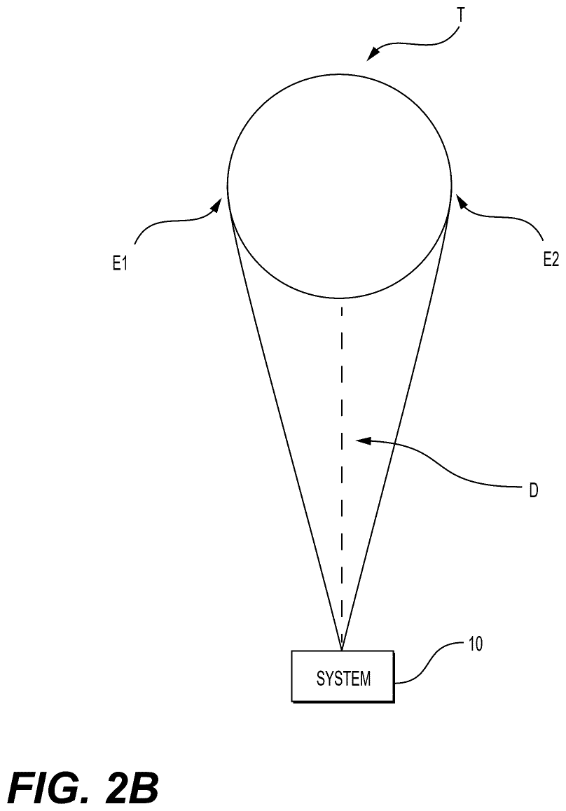

As shown in FIGS. 2A and 2B, the user moves system 10 into the vicinity of a selected tree T. A digital image of the tree T, within the pre-established plot of land, and the surrounding region is then recorded with a camera 14 of system 10. As noted above, system 10 may be implemented using, or may include, a mobile device, such as a smartphone or the like, and camera 14 may be, as a non-limiting example, a conventional smartphone camera, with the augmented reality display (ARD), including the image of the tree T and the surrounding region, being displayed on the display 22 of the smartphone. As shown in FIG. 2A, the image of the surrounding region includes at least an image of the ground surface.

A digital image of the tree T and the surrounding region is displayed to the user on display 22 and a vertical line L is overlayed on the digital image of the tree T and the surrounding region. The user positions the camera such that the vertical line L is overlayed on the tree T between its edges, as shown in FIG. 2A. As a non-limiting example, when system 10 is implemented using a smartphone, or includes a smartphone, the display 22 and interface 23 may be a single touchscreen, and the user views the touchscreen while moving the smartphone to move the vertical line L within the boundaries of the tree. However, it should be understood that interface 23 may be any suitable type of user interface.

As shown, the vertical line L has a lower end which terminates at an intersection marker I. The user also positions the vertical line L such that the intersection marker I at the lower end of the vertical line L overlays the intersection between the bottom of the tree T and the ground surface. As shown, the vertical line L is vertical and may be used to define a horizontal distance such that a diameter of the tree T may be measured along the horizontal direction.

System 10 determines the edges E1 and E2 to the left and right, respectively, of the vertical line L. The edges E1 and E2 are both identified and localized; i.e., the coordinates of the edges E1 and E2 with respect to the augmented reality display (ARD) are determined. The depth image is used to determine the coordinates of the edges E1 and E2. It should be understood that any suitable type of edge locating algorithm may be used, as is well-known in the art. For example, color contrast may be used to determine the locations of edges E1 and E2 in the digital image.

A distance D between the system 10 and the tree T is measured using a distance measuring subsystem 25, such as a conventional depth sensor, range finder, depth camera, LiDAR range finder or the like. As a non-limiting example, a smartphone used to implement system 10 may include a range finder or may be connected to a range finder. It should be understood that based on the measured distance D and known parameters of the camera, the diameter of the tree at a specified height may be calculated using any suitable method. As a non-limiting example, if the horizontal and vertical coordinates on the screen of edges E1 and E2 are given by (u₁, v₁) and (u₂, v₂), respectively, at a known height above the ground, then the focal length of the camera, f, which is known, and the coordinates of

the principal point, (cₓ, c_{y}), which are known, may be used to convert the coordinates of the edges E1 and E2 into a “real world” diameter. As is well known in the fields of photography and optics, the principal point is the point on the image plane onto which the perspective center is projected. It is also the point from which the focal length of the lens is measured. This is a known quantity for the camera. The coordinates in the camera reference frame are given by x′₁=u₁·f+cₓ; y′₁=v₁·f+c_{y}; x′₂=u₂·f+cₓ; and y′₂=v₂·f+c_{y}. These coordinates can then be scaled to the object reference frame as x₁=x′₁·z₁; y₁=y′₁·z₁; x₂=x′₂·z₂; and y₂=y′₂·z₂, where z₁ and z₂ are the values from the depth image at (u₁, v₁) and (u₂, v₂), respectively. The “real world” diameter of the tree at the given height is then calculated as the absolute value of the difference between the two vectors (x₁, y₁) and (x₂, y₂). Thus, for any virtual distance measured between the edges E1 and E2 of the tree T as displayed in the digital image, the measured virtual distance can be converted into a real diameter of the tree T. It should be understood that any suitable technique may be used to convert the virtual distance into the physical diameter of the tree T. It should be further understood that the diameter of tree T at any desired height may be measured, however, in forest inventories, it is conventional to measure the diameter at breast height (DBH), which is defined in the field of forestry as 4.5 feet above ground. The location of the tree T is determined using the GPS receiver 16 or the like and,

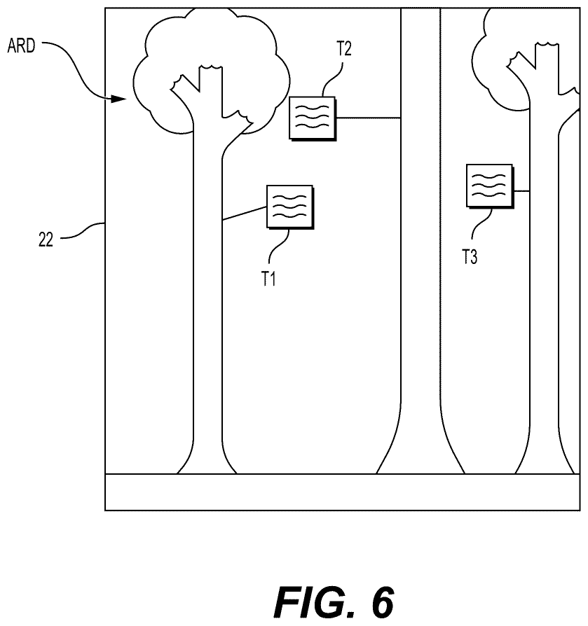

as shown in FIG. 6, the tree T is virtually tagged in the augmented reality display (ARD) shown in display 22 with a virtual tag including data representative of the diameter of the tree T and the location of the tree T. This process may be repeated for any desired number of trees within the pre-established plot. In the non-limiting example of FIG. 6, three such trees are shown respectively tagged with virtual tags T1, T2 and T3. The GPS receiver 16, a GNSS receiver or the like is either integrated into the device or is positioned on the device, thus the received location coordinates may be used in combination with the distance and angle to the tree stem of interest to calculate the geographic position of the tree stem; i.e., the device does not have to moved to contact the tree stem in order to obtain accurate coordinates for use in virtually tagging the tree, rather, the known distance and angle of the tree stem from the located device can be easily calculated via trigonometry.

Returning to FIG. 2A, the virtual boundary (VB) image of the boundary of the pre-established plot of land may also be overlayed on the digital image of the tree T and the surrounding region. In the above, the GPS coordinates measured by system 10 were used to determine the locations of the tree T. However, the location of the tree T may also be determined in relation to the virtual marker (VM) (of FIG. 1), using pose tracking or the like, or in combination therewith.

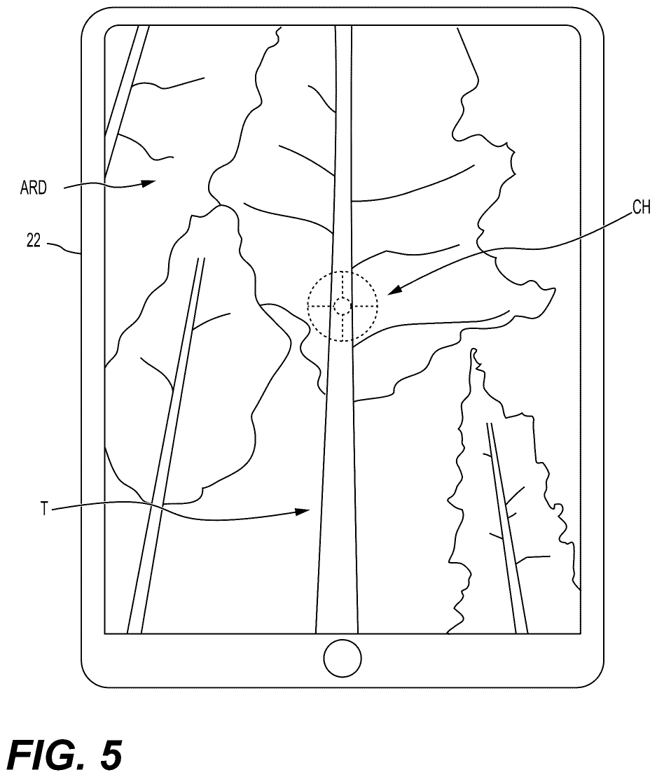

Additionally, as shown in FIG. 5, a height marker may be overlayed on the digital image of the tree T, such that the user can position the height marker such that the height marker is overlayed on the tree T at a desired height. In the non-limiting example of FIG. 5, the height marker is shown as virtual crosshairs CH. An angle of inclination of the system 10 is determined when the height marker is overlayed on the tree T at the desired height, and the height of the tree T at a point indicated by the height marker can then be determined based on the angle of inclination of the system 10 and the distance D between the system 10 and the tree T.

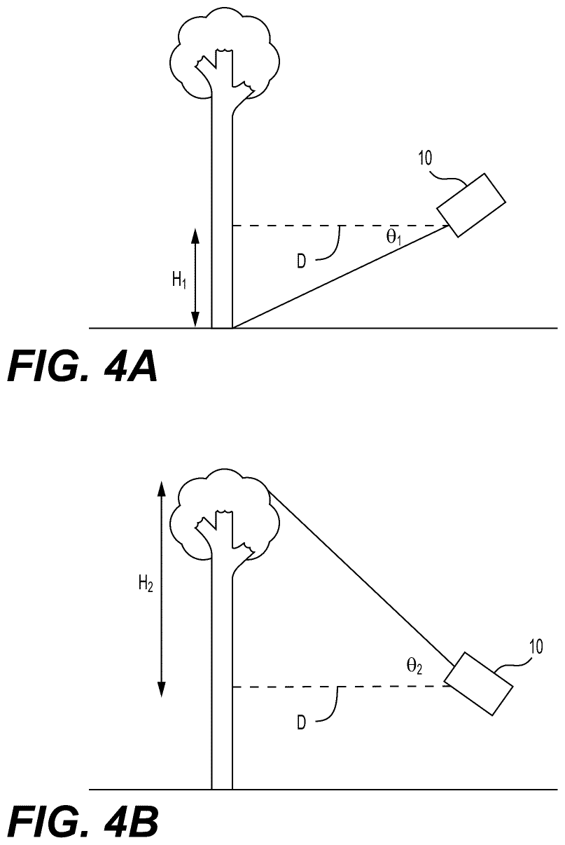

As shown in FIGS. 4A and 4B, the full height of the tree T, at the desired height, may be determined as a two-step process. The system 10 may first be angled downwardly to determine an angle of declination θ₁ from the height of system 10 above the ground to the point where the tree T intersects with the ground, as shown in FIG. 4A. At the measured distance D between system 10 and the tree T (measured horizontally), the height H₁ of tree T at the height of system 10 is given by H₁=Dtanθ₁. Next, as shown in FIG. 4B, the system 10 may be angled up to determine the angle of inclination θ₂ from the height of system 10 to the height indicated by crosshairs CH on the ARD. At the measured distance D between system 10 and the tree T (measured horizontally), the height H₂ of tree T from the height of system 10 to the height indicated by crosshairs CH is given by H₂=Dtanθ₂. The total height from the ground to the point indicated by crosshairs CH is the calculated as H₁+H₂.

The angles of declination and inclination may be determined using any suitable type of angle or tilt sensor. In the non-limiting example of system 10 being implemented using a smartphone, or including a smartphone, the conventional angle or tilt sensor 18 integrated into the smartphone may be used. It should be understood that the calculations described above may be performed by any suitable type of controller 12. In the non-limiting example of system 10 being implemented using a smartphone, or including a smartphone, the on-board processor of the smartphone may be used as controller 12. However, it should be understood that controller 12 may also be any suitable type of controller, processor, programmable logic controller or the like. As shown in FIG. 3, controller 12 is in communication with the non-transitory computer readable memory 20, display 22, interface 23, camera 14, angle or tilt sensor 14, location determining subsystem 16, and distance measuring sub-system 25. As discussed above, as a non-limiting example, each of these components may be incorporated into, or be used in combination with, a mobile device, such as a smartphone, tablet computer or the like.

The virtual tags T1, T2 and T3 associated with the trees may also include data representative of the height of the trees, which may be measured as described above. The user may also append the virtual tags with data representative of the species of the trees. By storing images of trees and their input species in memory 20, a training database may be established for a machine learning-based tree identification system.

The above process can be performed for any desired number of trees within the pre-established plot of land. Using the virtual tags T1, T2 and T3 and the augmented reality display (ARD) showing the virtual boundary VB and the location of the plot center via the virtual marker VM, a forest inventory can be effectively performed within a well-defined plot boundary (shown to the user on display 22) and within a known area and/or distance from the plot center, and also with inventoried trees readily tagged and indicated to the user, thus allowing for sampling without the errors inherent in manual inventorying processes.

It is to be understood that the system and method for performing a forest inventory are not limited to the specific embodiments described above, but encompasses any and all embodiments within the scope of the generic language of the following claims enabled by the embodiments described herein, or otherwise shown in the drawings or described above in terms sufficient to enable one of ordinary skill in the art to make and use the claimed subject matter.

1. A method for performing a forest inventory, comprising:
recording a digital image of a tree and a surrounding region with a camera, wherein the surrounding region includes at least a ground surface;
displaying the digital image of the tree and the surrounding region to a user;
overlaying a vertical line on the digital image of the tree and the surrounding region;
the user positioning the camera such that the vertical line is overlayed on the tree between edges thereof and such that a lower end of the vertical line overlays an intersection between a bottom of the tree and the ground surface;
identifying and localizing the edges of the tree in the digital image of the tree and the surrounding region;
measuring a distance between the camera and the tree;
measuring a virtual distance between the edges of the tree displayed in the digital image;
converting the virtual distance into a diameter of the tree;
determining a location of the tree; and
virtually tagging the tree in the digital image with a virtual tag including data representative of the diameter of the tree and the location of the tree.

2. The method for performing a forest inventory as recited in claim 1, further comprising:
determining a geographic center of a pre-established plot of land in which the tree is located;
recording a digital image of at least a portion of the pre-established plot of land; and
overlaying a reference marker image on the digital image of the at least a portion of the pre-established plot of land at the geographic center thereof.

3. The method for performing a forest inventory as recited in claim 2, further comprising:
determining a boundary of the pre-established plot of land; and
overlaying a boundary image on the digital image of the at least a portion of the pre-established plot of land, the boundary image being representative of the boundary of the pre-established plot of land.

4. The method for performing a forest inventory as recited in claim 3, further comprising:
overlaying the boundary image on the digital image of the tree and the surrounding region.

5. The method for performing a forest inventory as recited in claim 1, further comprising:
overlaying a height marker on the digital image of the tree and the surrounding region;
the user positioning the height marker such that the height marker is overlayed on the tree at a desired height;
determining an angle of inclination of the camera when the height marker is overlayed on the tree at the desired height; and
determining the height of the tree at a point indicated by the height marker based on the angle of inclination of the camera and the distance between the camera and the tree,
wherein the virtual tag further includes data representative of the height of the tree.

6. The method for performing a forest inventory as recited in claim 1, wherein the virtual tag further includes data representative of the species of the tree.

7. A system for performing a forest inventory, comprising:
a display;
a user interface;
means for determining location;
means for measuring distance;
a camera;
non-transitory computer readable memory; and
a controller in communication with the display, the user interface, the means for determining location, the means for measuring distance, the camera and the non-transitory computer readable memory, the controller being configured for:
recording a digital image of a tree and a surrounding region with the camera, wherein the surrounding region includes at least a ground surface, and wherein the digital image of the tree and the surrounding region is stored in the non-transitory computer readable memory;
displaying the digital image of the tree and the surrounding region to a user on the display;
overlaying a vertical line on the digital image of the tree and the surrounding region;
the user positioning the camera such that the vertical line is overlayed on the tree between edges thereof and such that a lower end of the vertical line overlays an intersection between a bottom of the tree and the ground surface;
identifying and localizing the edges of the tree in the digital image of the tree and the surrounding region;
measuring a distance between the camera and the tree using the means for measuring distance;
measuring a virtual distance between the edges of the tree displayed in the digital image;
converting the virtual distance into a diameter of the tree;
determining a location of the tree using the means for determining location; and
virtually tagging the tree in the digital image with a virtual tag including data representative of the diameter of the tree and the location of the tree.

8. The system for performing a forest inventory as recited in claim 7, wherein the controller is further configured for:
recording a digital image of at least a portion of a pre-established plot of land with the camera; and
overlaying a reference marker image on the digital image of the at least a portion of the pre-established plot of land at a geographic center thereof.

9. The system for performing a forest inventory as recited in claim 8, wherein the controller is further configured for overlaying a boundary image on the digital image of the at least a portion of the pre-established plot of land, the boundary image being representative of a boundary of the pre-established plot of land.

10. The system for performing a forest inventory as recited in claim 9, wherein the controller is further configured for overlaying the boundary image on the digital image of the tree and the surrounding region.

11. The system for performing a forest inventory as recited in claim 7, further comprising means for determining an angle of inclination of the camera, wherein the controller is further configured for:
overlaying a height marker on the digital image of the tree and the surrounding region;
the user positioning the height marker using the user interface such that the height marker is overlayed on the tree at a desired height;
determining an angle of inclination of the camera using the means for determining an angle of inclination of the camera when the height marker is overlayed on the tree at the desired height; and
determining the height of the tree at a point indicated by the height marker based on the angle of inclination of the camera and the distance between the camera and the tree,
wherein the virtual tag further includes data representative of the height of the tree.

12. The system for performing a forest inventory as recited in claim 7, wherein the virtual tag further includes data representative of the species of the tree.
